(19) United States
(12) Patent Application Publication
(10) Pub. No.: US 2013/0185745 A1
(43) Pub. Date: Jul. 18, 2013

(54) METHOD, SYSTEM AND TELEVISION FOR PICTURE REPRODUCTION

(71) Applicant: MStar Semiconductor, Inc., Hsinchu County (TW)

(72) Inventors: Ren-Zhen Zheng, Hsinchu County (TW); Jian-Qun Jiang, Hsinchu County (TW)

(73) Assignee: MStar Semiconductor, Inc., Hsinchu County (TW)

(21) Appl. No.: 13/684,911

(22) Filed: Nov. 26, 2012

(30) Foreign Application Priority Data
Jan. 17, 2012 (CN) 201210013830.9

(51) Int. Cl. H04N 21/258; H04N 21/63

(52) U.S. Cl. CPC H04N 21/25875; H04N 21/63
USPC 725/25; 725/74; 725/93

(57) ABSTRACT

A method, system, and television for television picture reproduction via a network is provided. The television receives picture reproduction request information sent from a terminal device, real-time encodes video and audio data inputted from a multimedia server, respectively packs the encoded video and audio data into video data packets and audio data packets, and sends the video data packets and the audio data packets to the terminal device. The terminal device performs playback according to the video data packets and the audio data packets. Thus, the method accomplishes television picture reproduction through a network to fulfill short-distance picture reproduction requirements without occupying resources and network bandwidth of the multimedia server.

This application claims the benefit of People's Republic of China application Serial No. 201210013830.9, filed Jan. 17, 2012, the subject matter of which is incorporated herein by reference.

### BACKGROUND OF THE INVENTION

1. Field of the Invention

The present disclosure relates in general to a network communication technique, and more particularly to a method, system television and terminal device for reproducing a television picture through a local area network (LAN).

2. Description of the Related Art

A multimedia server provides centralized management on multimedia contents using a centralized content management system, and broadcasts the multimedia contents using a form of an electronic program function list to various platforms including Internet protocol televisions (IPTV), personal computers, and mobile terminals.

An interaction support system of a multimedia server manages basic information data of multiple playback images, including user accounts and relations of different display images and user accounts. When a user wishes to transfer contents on a television screen to a mobile terminal or a personal computer, the mobile terminal or the personal computer first obtains a centralized authentication from a central media system of the multimedia server. The central media system then sends corresponding multimedia streams, which are received and played by the mobile terminal or the personal computer.

In current picture reproduction techniques, due to the mandatory centralized management and authentication provided by the central media system, not only are supported picture reproduction contents quite limited, but resources and network bandwidth utilized by the multimedia server are occupied, such that requirements of short-distance picture reproduction cannot be properly and efficiently fulfilled.

### SUMMARY OF THE INVENTION

The present disclosure is directed to a method for reproducing a television picture through a local area network (LAN) as well as to an associated system, television, and terminal device, which are capable of television picture reproduction in the LAN and fulfilling requirements of short-distance picture reproduction without occupying resources and network bandwidth of a multimedia server.

According to an aspect of the disclosure, a method for picture reproduction for a terminal device and a television is provided. The terminal device and the television are signally connected to each other via a local area network (LAN). The method includes the steps of: sending picture reproduction request information from the terminal device to the television; after the television receives the picture reproduction request information, encoding a video data and an audio data inputted from a multimedia server in real-time, and packing the encoded video data and the encoded audio data to respectively generate at least one video data packet and at least one audio data packet to the terminal device; and performing playback by the terminal device according to the video data packet and the audio data packet received.

According to another aspect of the disclosure, a television is provided. The television, signally connected to a terminal device, includes: a stream service module, signally connected to the terminal device, for receiving picture reproduction request information sent from the terminal device; a video encoding module, electrically connected to the stream service module performs real-time encoding of a video data in a local scaler according to the picture reproduction request information; and an audio encoding module, electrically connected to the stream service module, performs real-time encoding an audio data inputted from a multimedia server according to the picture reproduction request information. The stream service module obtains at least one video data packet and at least one audio data packet according to the encoded video data and the encoded audio data, and sends the at least one video data packet and the at least one audio data packet to the terminal device, so as to allow the terminal device to accordingly perform playback.

According to yet another aspect of the disclosure, a system for picture reproduction is provided. The system includes a terminal device, and a television signally connected to the terminal device. The television receives picture reproduction request information sent from the terminal device, encodes a video data and an audio data inputted from a multimedia server according to the picture reproduction request information in real-time, obtains at least one video data packet and at least one audio data packet according to the encoded video data and the encoded audio data, and sends the at least one video data packet and the at least one audio data packet to the terminal device. The terminal device receives the at least one video data packet and the at least one audio data packet, and performs playback according to the at least one video data packet and the at least one audio data packet.

Different from prior art conventional solutions, the disclosure provides various advantages. In the disclosure, the television receives the picture reproduction request information sent from the terminal device, and encodes in real-time the video data and the audio data inputted from the multimedia server. The television then packs the encoded video data and audio data into video data packets and audio data packets, and sends the video data packets and audio data packets to the terminal device, so as to allow the terminal device to perform playback according to the video data packets and the audio data packets. Thus, the method of the disclosure is capable of accomplishing television picture reproduction in a home LAN to fulfill requirements of short-distance television picture reproduction without occupying the resources and network bandwidth of the multimedia server.

The above and other aspects of the present disclosure will become better understood with regard to the following detailed description of the preferred but non-limiting embodiments. The following description is made with reference to the accompanying drawings.

### BRIEF DESCRIPTION OF THE DRAWINGS

FIGS. 1A and 1B are flowcharts of a method for television picture reproduction in a home LAN according to an embodiment of the disclosure.

FIG. 2 is a schematic diagram of a process of a system for television picture reproduction in a home LAN according to an embodiment of the disclosure.

FIG. 3 is a block diagram of a television according to an embodiment of the disclosure.

FIG. 4 is a block diagram of a terminal device according to an embodiment of the disclosure.

### DETAILED DESCRIPTION OF THE INVENTION

In an embodiment of the disclosure, a television and a terminal device are connected to communication with each other through a local area network (LAN), e.g., a home LAN.

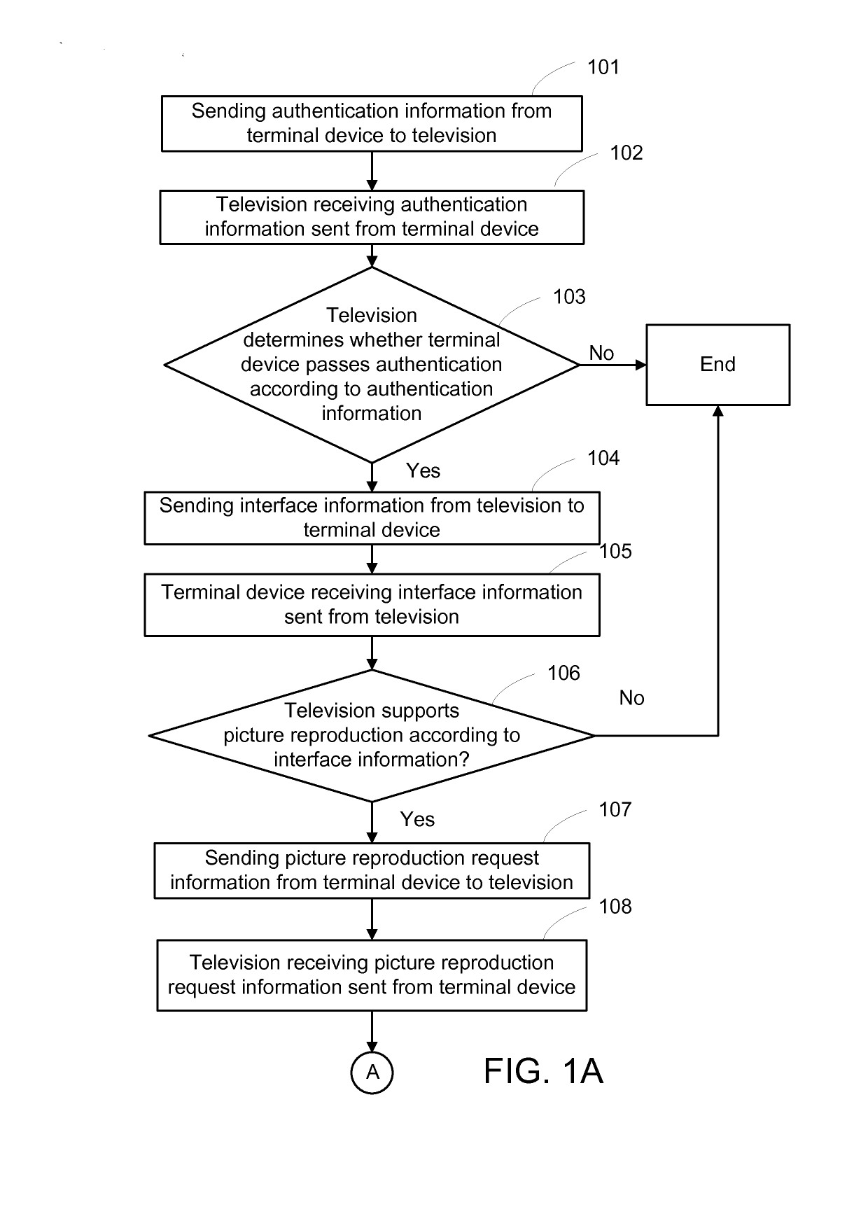

FIGS. 1A and 1B are flowcharts of a method for reproducing a television picture in a LAN according to an embodiment of the disclosure. The method includes the following steps.

In Step 101, the terminal device sends authentication information to the television. That is, the terminal device (such as a mobile phone or a personal computer) activates at least a corresponding terminal application, obtains an IP address of the home LAN through the universal plug-and-play (UPnP) protocol, and sends a connection request and authentication information to the television using the IP address.

In Step 102, the television receives the authentication information sent from the terminal device. That is, the television receives the connection request and the authentication information sent by the terminal device.

In Step 103, the television determines whether the terminal device passes authentication. That is, after receiving the connection request and the authentication information, the television judges whether the authentication information passes the authentication, i.e., a determination is made about whether the authentication is valid. When the authentication fails, the connection is terminated and the application ends. Step 104 is performed when the authentication is successful.

In Step 104, the television sends interface information of the television to the terminal device. That is, when the terminal device passes the authentication, the communication connection between the terminal device and the television is confirmed and established. The television sends the interface information of the television to the terminal device, so as to allow the terminal device to determine whether the television supports picture reproduction according to the interface information.

In Step 105, the terminal device receives the interface information from the television. In Step 106, the terminal device determines whether the television supports picture reproduction. The process ends when the television does not support picture reproduction, or else Step 107 is performed when the television supports picture reproduction.

In Step 107, when the terminal device determines that the television terminal in the LAN supports picture reproduction, the terminal device sends picture reproduction request information to the television.

The television receives the picture reproduction request information from the terminal device in Step 108, and real-time encodes a video data and an audio data inputted from a multimedia server according to the picture reproduction request information. More specifically, in Step 109, after receiving the picture reproduction request information according to the real-time transfer streaming protocol, the television starts real-time encoding the video data and the audio data inputted from the multimedia server.

In Step 110, the encoded video data and audio data are packed into video data packets and audio data packets, which are sent to the terminal device. That is, after encoding the video data and the audio data, the video data and the audio data are packed according to the real-time transfer protocol to generate video data packets and audio packets that are then sent to the terminal device.

In Step 111, the terminal device receives the video data packets and the audio data packets sent from the television according to the picture reproduction request information. In Step 112, after receiving the video data packets and the audio data packets from the television according to the picture reproduction request information, the terminal device unpacks according to the real-time transfer protocol and decompresses according to a predetermined protocol to accordingly perform playback.

In Step 113, the terminal device sends an analog remote controller button command. For example, a user may remotely control the television through the terminal device. More specifically, the terminal device sends an analog remote controller button command to the television through the LAN, and the television receives the analog remote controller button command from the terminal device. The television then converts the remote controller button command to a control instruction that can be identified and executed by the television to perform a corresponding operation, e.g., a channel switching control instruction or a volume adjustment control instruction.

In Step 114, the television receives the analog remote controller button command from the terminal device. In Step 115, after receiving the analog remote controller button command, the television converts the analog remote controller button command to a control instruction that can be identified and executed by the television.

In Step 116, after converting the received analog remote controller button command to the control instruction that can be identified and executed by the television, the television performs a corresponding operation according to the control instruction, e.g., a channel switching control instruction or a volume adjustment control instruction.

In this embodiment, given that internal operating modules of the television are in an operating status, the screen of television may be turned on or off.

In this embodiment, the television receives the picture reproduction request information sent from the terminal device, and real-time encodes the video data and the audio data inputted from the multimedia server. The television then packs the encoded video data and audio data into video data packets and audio data packets, and sends the video data packets and audio data packets to the terminal device, so as to allow the terminal device to perform playback according to the video data packets and the audio data packets.

Thus, the method of the disclosure, without occupying the resources and network bandwidths of the multimedia server, is capable of efficiently accomplishing television picture reproduction to fulfill requirements of short-distance television picture reproduction within a household. Further, the user is allowed to perform control operations on the television while watching a television program on the television, thereby further providing user convenience and enhancing user experiences.

According to a preferred embodiment of the disclosure, a system for implementing television picture reproduction includes a terminal device and a television, which are signally connected to each other through a network.

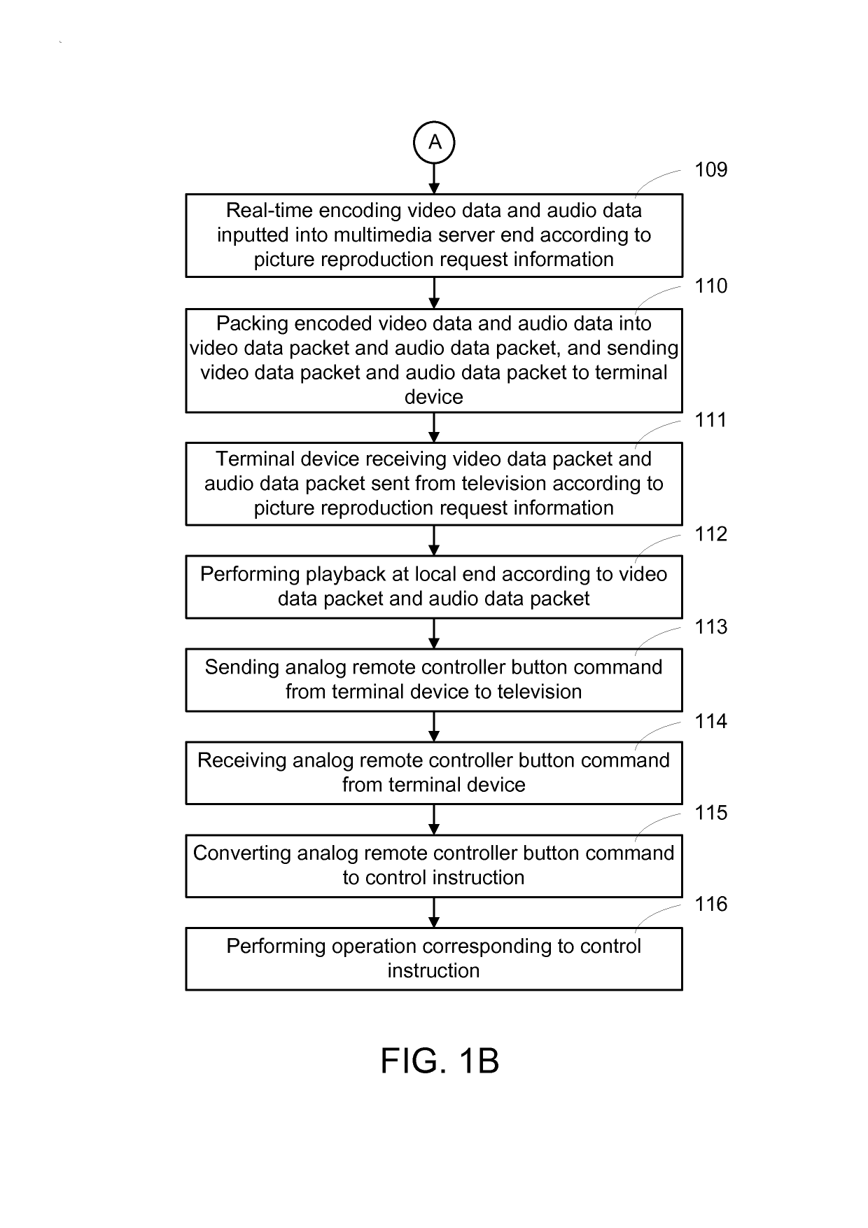

FIG. 2 shows a flowchart of a communication process between a terminal device and a television according to a preferred embodiment of the disclosure. In FIG. 2, steps on the left axis are performed by the terminal device, steps on the right axis are performed by the television, and steps having arrowed lines in the middle are steps associated with communication and function shared between both the terminal device and the television. The communication process between the terminal device and the television includes the following steps.

1. The terminal device connects to a network, and searches for a device in a same LAN through a peer networking connection universal plug-and-play (UPnP) protocol. That is, a terminal device such as a mobile phone or a personal computer activates a corresponding terminal application, and searches for a device in the same LAN through the UPnP protocol.

2. The terminal device finds the television in the LAN, and sends a connection request to the television.

3. The television in the home LAN receives the connection request from the terminal device.

4. Protocol handshakes and safety authentication are performed. That is, the television and the terminal device directly perform at least one handshake operation according to a handshake protocol and perform the safety authentication. The connection is terminated when the authentication fails to discontinue the connection request. When the authentication is successful, the terminal device obtains corresponding information from the television, e.g., an identification and interface information of the television.

5. The terminal device determines whether the television supports picture reproduction according to the interface information obtained from the protocol handshake and the safety authentication.

If the television supports picture reproduction, a corresponding status indicating that picture reproduction is supported is displayed on a display interface of the terminal device. If the television does not support picture reproduction, a corresponding status indicating that picture reproduction is not supported is displayed on the display interface of the terminal device to inform that the user not to further attempts to perform the picture reproduction operation.

6. The terminal device determines that the television in the LAN supports picture reproduction, and sends picture reproduction request information to the television.

7. The picture reproduction request information is received, and a video data and an audio data inputted from a multimedia server are real-time encoded according to the picture reproduction request information.

After receiving the picture reproduction request information according to the real-time transport streaming protocol, the television starts encoding the video data and the audio data inputted from the multimedia server. More specifically, the video data inputted from the multimedia server is typically stored in a video scaler of a local end, and so the audio data inputted from the multimedia server is real-time encoded when performing encoding.

For example, an encoding format is typically an advanced audio coding (AAC) format or an MP3 format; the video data that is real-time encoded is obtained from the scaler, and is in an encoding format such as an H264 format or an H263+ format.

To obtain optimal graphic effects of a display device, an image is displayed on a particular screen at a predetermined resolution. A resolution of a signal at an input end is determined by a user demand and an input terminal device. Therefore, to solve the issue of the resolution mismatch between the input terminal and the liquid-crystal display (LCD), input images having different resolutions are scaled to a predetermined resolution supported by the LCD. Accordingly, the video data inputted from the multimedia server need to be processed by a scaler.

8. The encoded packet data and audio data are packed into at least one video data packet and at least one audio data packet.

After real-time encoding the video data and the audio data, the television packs the encoded data and audio data according to the real-time transfer protocol.

9. The television sends the video data packets and the audio data packets to the terminal device.

10. The terminal device receives the video data packets and the audio data packets from the television, unpacks according the real-time transfer protocol, and decompresses the received video data packets and audio data packets according to a predetermined protocol to perform playback.

11. An analog remote controller button command is sent to the television. More specifically, the user may remote control the television by the terminal device, and the terminal device is allowed to send the analog remote controller button command to the television through the LAN. For example, the analog remote controller button command is a channel switching instruction or a volume adjustment instruction of an analog remote controller.

12. The received simulated remote controller button command is converted into a control instruction, and a corresponding operation is performed according to the control instruction.

After receiving the analog remote controller button command sent from the terminal device, the television converts the analog remote controller button command to a control instruction that can be identified and executed by the television, and performs a corresponding operation, e.g., a channel switching control instruction or a volume adjustment control instruction.

In this embodiment, given that internal operating modules of the television are in an operating status, the screen of television may be turned on or off.

In this embodiment, the television receives the picture reproduction request information sent from the terminal device, and real-time encodes the video data and the audio data inputted from the multimedia server. The television then packs the encoded video data and audio data into video data packets and audio data packets, and sends the video data packets and audio data packets to the terminal device, so as to allow the terminal device to perform playback according to the video data packets and the audio data packets.

Thus, the method of the disclosure, without occupying the resources and network bandwidth of the multimedia server, is capable of accomplishing television picture reproduction to fulfill requirements of short-distance television picture reproduction within a proximal area, like a household or vehicle. Further, the user is allowed to perform control operations on the television while watching a television program on the television, thereby further providing user convenience and enhancing user experiences.

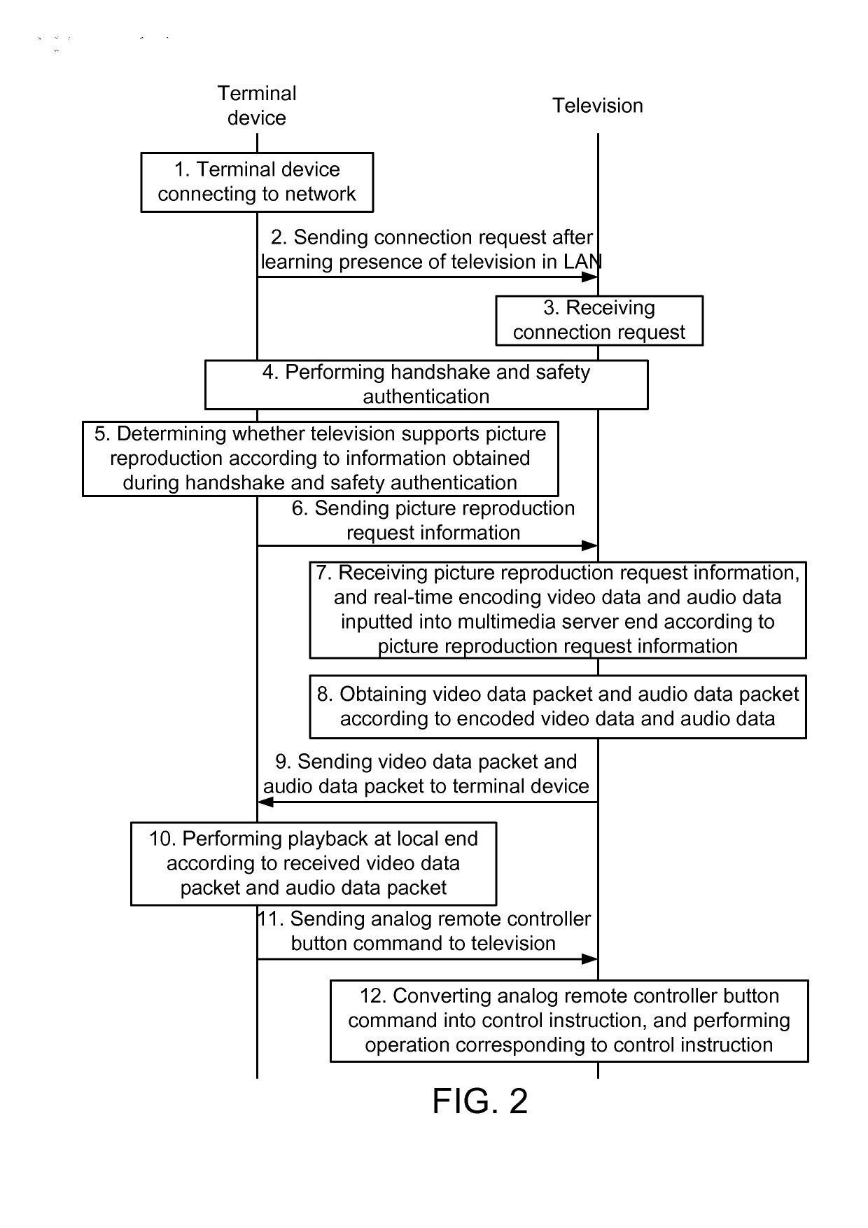

FIG. 3 shows a block diagram of a television according to a preferred embodiment of the disclosure.

Referring to FIG. 3, a television 40 includes a stream service module 401, a video encoding module 402, an audio encoding module 403, a control module 404, a scaler 405, and a digital input module 406.

The digital input module 406 is coupled with the audio encoding module 403 and the scaler 405. The scaler 405 is coupled with the video encoding module 402 and the control module 404. The audio encoding module 403 is coupled with the control module 404 and the stream service module 401. The video encoding module 402 and the control module 404 are respectively coupled with the stream service module 401.

To obtain optimal graphic effects of a display device, an image is displayed on a particular screen at a predetermined resolution. A resolution of a signal at an input end is determined by a user demand and an input terminal device.

Therefore, to solve the issue of the resolution mismatch between the input terminal and the LCD, input images having different resolutions are scaled to a predetermined resolution supported by the LCD. Accordingly, the video data inputted from the multimedia server need to be processed by a scaler.

The stream service module 401 receives picture reproduction request information sent from a terminal device 50.

The video encoding module 402 real-time encodes the video data in the local scaler 405 according to the picture reproduction request information received by the stream service module 401.

The audio encoding module 403 real-time encodes the audio data inputted from a multimedia server according to the picture reproduction request information received by the stream service module 401.

The stream service module 401 further packs the encoded video data and audio data to respectively generate audio data packets and audio data packets. The stream service module 401 then sends the video data packets and the audio data packets to the terminal device, so as to allow the terminal device 50 to perform playback according to the video data packets and the audio data packets.

The television 40 in this embodiment further includes a control module 404. The control module 404 receives authentication information sent from the terminal device, and determines whether the terminal device passes authentication. If the authentication is successful, interface information of the television is sent to the terminal device to allow the terminal device to determine whether the television supports picture reproduction according to the interface information.

The control module 404 further receives an analog remote controller button command sent from the terminal device, converts the analog remote controller button command to a control instruction, and performs a corresponding operation according to the control instruction. More specifically, the control module 404 controls the selection of the data to be encoded in the audio encoding module 403 and in the scaler 405 according to the control instruction. That is, the control module 404 controls the data process between the stream service module 401 and the terminal device according to the control instruction.

The television 40 in this embodiment further includes a digital input module 406. The digital input module 406 is an interface between the television and the multimedia server, and supports inputs of various data sources, e.g., ATV, DTV, AV, HDMI, and PC.

In this embodiment, the television 40 receives the picture reproduction request information sent from the terminal device 50, and real-time encodes the video data and the audio data inputted from the multimedia server. The television then packs the encoded video data and audio data into video data packets and audio data packets, and sends the video data packets and audio data packets to the terminal device, so as to allow the terminal device to perform playback according to the video data packets and the audio data packets.

Thus, the method of the disclosure, without occupying the resources and network bandwidth of the multimedia server, is capable of accomplishing television picture reproduction to fulfill requirements of short-distance television picture reproduction within a household. Further, the user is allowed to perform control operations on the television while watching a television program on the television, thereby further providing user convenience and enhancing user experiences.

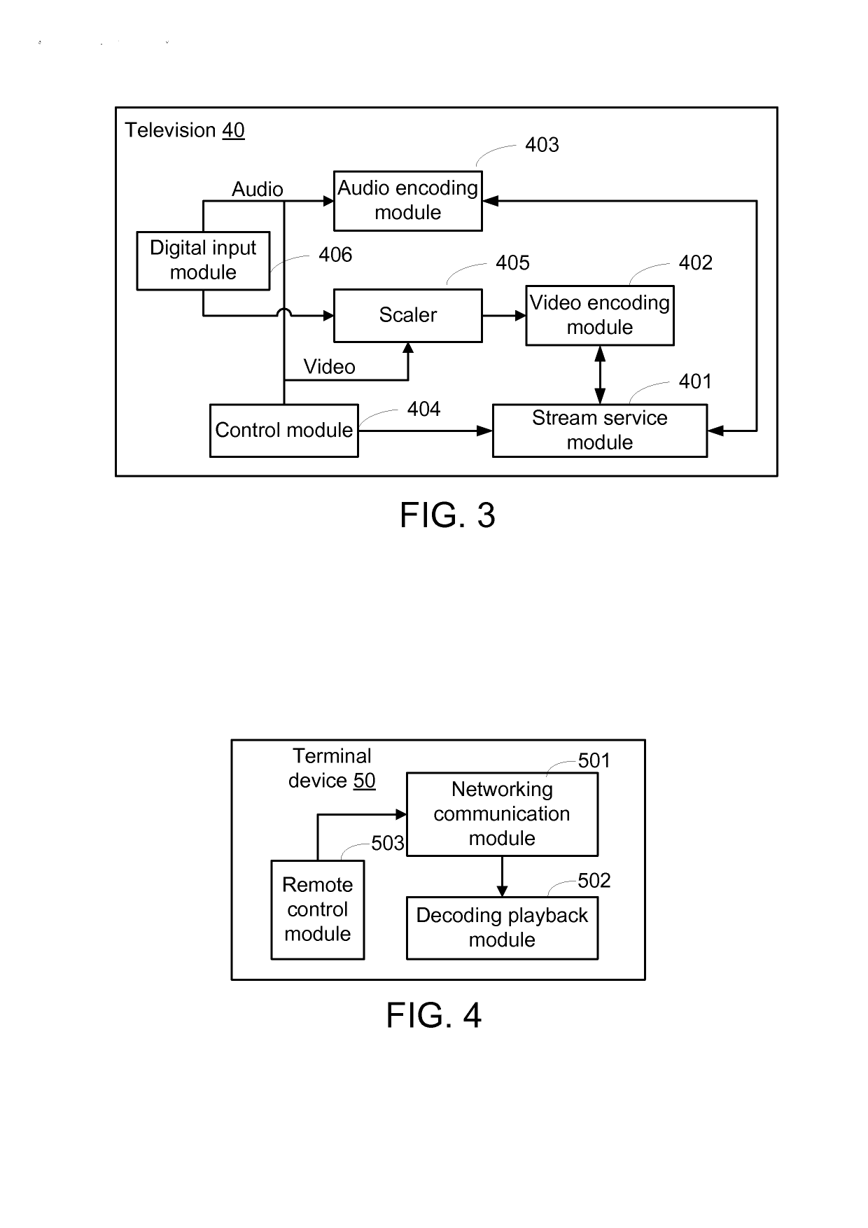

FIG. 4 shows a block diagram of a terminal device according to an embodiment of the disclosure.

Referring to FIG. 4, a terminal device 50 includes a networking communication module 401, a decoding playback module 502, and a remote control module 503. The networking communication module 401 is electrically connected to the decoding playback module 502 and the remote control module 503.

The networking communication module 501 sends picture reproduction request information to the television 40, and receives video data packets and audio data packets sent from the television 40 according to the picture reproduction request information.

The decoding playback module 502 performs playback according to the video data packets and the audio data packets received by the networking communication module 501.

The networking communication module 501 further sends authentication information to the television 40, receives interface information sent from the television 40, and determines whether the television 40 supports picture reproduction according to the received interface information.

An analog remote controller button command is sent to the television. More specifically, an analog remote controller button command is obtained by the remote control module 503 through a user operation, and is sent to the networking communication module 501 by the remote control module 503 and sent to the television 40 by the networking communication module 501.

In this embodiment, the terminal device 50 and the television 40 are connected to each other in a home LAN or other small network. After the terminal device 50 sends picture reproduction request information to the television 40, the television 40 sends video data packets and audio data packets according to the picture reproduction request information. After receiving the video data packets and the audio data packets, the terminal device 40 performs playback at a local end according to contents of the video data packets and the audio data packets.

Thus, the method of the disclosure, without occupying the resources and network bandwidth of the multimedia server, is capable of accomplishing television picture reproduction to fulfill requirements of short-distance television picture reproduction within a household. Further, the user is allowed to perform control operations on the television while watching a television program on the television, thereby further providing user convenience and enhancing user experiences.

While the present disclosure has been described by way of example and in terms of the preferred embodiments, it is to be understood that the present disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for picture reproduction for a terminal device and a television, the terminal device and the television being signally connected to each other via a home local area network (LAN), the method comprising:
sending picture reproduction request information from the terminal device to the television;
after the television receives the picture reproduction request information, real-time encoding a video data and an audio data from a multimedia server, packing the encoded video data and the encoded audio data to generate at least one video data packet and at least one audio data packet, and sending the at least one video data packet and the at least one audio data packet to the terminal device; and
performing playback according to the video data packet and the audio data packet by the terminal device.

2. The method according to claim 1, further comprising:
sending authentication information from the terminal device to the television;
after the television receives the authentication information, determining whether the terminal device passes authentication according to the authentication information, and sending interface information of the television to the terminal device when the authentication is successful; and
receiving the interface information by the terminal device, determining whether the television supports picture reproduction according to the interface information, and performing the step of sending the picture reproduction request information to the television when the picture reproduction is supported.

3. The method according to claim 1, further comprising:
sending an analog remote controller button command from the terminal device to the television; and
after the television receives the analog remote controller button command, converting the analog remote controller button command to a control instruction, and performing an operation corresponding to the control instruction.

4. A television, signally connected to a terminal device, comprising:
a stream service module, signally connected to the terminal device, for receiving picture reproduction request information sent from the terminal device;
a video encoding module, electrically connected to the stream service module, for real-time encoding a video data in a local scaler according to the picture reproduction request information; and
an audio encoding module, electrically connected to the stream service module, for real-time encoding an audio data inputted from a multimedia server according to the picture reproduction request information;
wherein, the stream service module generates at least one video data packet and at least one audio data packet according to the encoded video data and the encoded audio data, and sends the at least one video data packet and the at least one audio data packet to the terminal device to allow the terminal device to accordingly perform playback.

5. The television according to claim 4, further comprising:
a control module, electrically connected to the stream service module, for receiving authentication information sent from the terminal device, determining whether the terminal device passes authentication according to the authentication information, when the authentication is successful, sending interface information to the terminal device to allow the terminal device to accordingly determine whether the television supports the picture reproduction.

6. The television according to claim 5, wherein the control module receives an analog remote controller button command sent from the terminal device, converts the analog remote controller button command to a control instruction, and performs an operation corresponding to the control instruction.

7. A system for picture reproduction, comprising:
a terminal device; and
a television, signally connected to the terminal device;
wherein, the television receives picture reproduction request information sent from the terminal device, real-time encodes a video data and an audio data inputted from a multimedia server according to the picture reproduction request information, generates at least one video data packet and at least one audio data packet according to the encoded video data and the encoded audio data, and sends the at least one video data packet and the at least one audio data packet to the terminal device; and
the terminal device receives the at least one video data and the at least one audio data packet, and performs playback according to the at least one video data and the at least one audio data packet.

8. The system according to claim 7, wherein the television further receives authentication information sent from the terminal device, determines whether the terminal device passes authentication according to the authentication information, and sends interface information to the terminal device when the authentication is successful; and the terminal device determines whether the television supports picture reproduction according to the interface information.

9. The system according to claim 7, wherein the terminal device further sends an analog remote controller button command to the television.

10. The system according to claim 7, wherein the television further receives an analog remote controller button command sent from the terminal device, converts the analog remote controller button command to a control instruction, and performs an operation corresponding to the control instruction.
